(19) United States
(12) Patent Application Publication
(10) Pub. No.: US 2025/0335451 A1
(43) Pub. Date: Oct. 30, 2025

(54) SYSTEMS AND METHODS FOR PERSONALIZED SUMMARIZATION TECHNIQUES USING RETRIEVAL AUGMENTED GENERATION

(71) Applicant: INTUIT INC., Mountain View, CA (US)

(72) Inventors: Rachit Debashish SENGUPTA, Mountain View, CA (US); Daniel M. LISHINGMAN, Mountain View, CA (US); Kenneth Grant Yocum, Mountain View, CA (US)

(73) Assignee: INTUIT INC., Mountain View, CA (US)

(21) Appl. No.: 18/651,668

(22) Filed: Apr. 30, 2024

(51) Int. Cl. G06F 16/2457; G06F 16/248

(52) U.S. Cl. CPC G06F 16/24578; G06F 16/248

(57) ABSTRACT

Systems and methods are provided that utilize personalized summarization techniques with retrieval augmented generation.

### BACKGROUND OF THE DISCLOSURE

Retrieval augmented generation (RAG) is a technique used in the field of artificial intelligence and machine learning. Retrieval augmented generation techniques can be used to further the benefits of generative artificial intelligence (AI), such as large language models (LLMs). The process generally involves taking a user query and finding the correct documents that match the query from a semantic perspective. These documents are then provided as an input to an LLM, which generates a response based on the input. However, this type of approach lacks personalization. In other words, the approach is unable to accommodate specific user preferences and characteristics, which is undesirable.

### BRIEF DESCRIPTION OF THE FIGURES

FIG. 1 is a block diagram of an example system for personalized summarization techniques using retrieval augmented generation according to example embodiments of the present disclosure.

FIG. 2 is a flowchart of an example process for personalized summarization techniques using retrieval augmented generation according to example embodiments of the present disclosure.

FIG. 3 is server device that can be used within the system of FIG. 1 according to an embodiment of the present disclosure.

FIG. 4 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Many organizations (e.g., businesses and other similar entities) utilize accounting or business management software. These software services typically have a large user base of businesses and thus large databases of business information. It is relatively common for these databases to not contain enough information about each business to allow significant or effective analysis of the database and the businesses within them. They may have lacking, incorrect, or misleading knowledge of the industry, category, or services/products offered by the business, and it is also not uncommon for the data that is stored in relation to a business to not be in a structured or useful format.

Moreover, many businesses do not select a category and/or description for his/her business when registering to use software or participate in an organization. A selected category can be helpful, but categories by themselves are quite broad and cannot offer extensive insight due to the extensive variety in business operations. Typically, a database will offer a small number of possible categories, e.g. sixteen categories. Examples of categories may be “Educational Services”, Wholesale Trade”, “Finance and Insurance”, “Manufacturing”, “Healthcare and Social Assistance”, and the like. In addition, databases also contain a description for each business, which is similarly left blank much of the time. But even when a description is provided, the allowance of free-form text can give rise to much inconsistency.

In addition, it is difficult to summarize the services or products offered by a business, despite databases typically having access to the business's invoices and bank transactions. Obtaining accurate and appropriate lists of business offerings (e.g., services and/or products) requires manual entry or adherence to a pre-defined list when selecting offerings. Due to these issues, it is often difficult to truly understand the nature of businesses and his/her operations within a database or in a software environment. This lack of understanding can limit the ability to identify fraud among businesses, understand which areas of industry are more susceptible to fraud, and what kind of services are more susceptible to fraud. It can also limit the ability to suggest new products or services to businesses or provide warnings based on mistakes from similar businesses in the past. All of these consequences are undesirable.

Embodiments of the present disclosure therefore relate to systems and methods for personalized summarization techniques using retrieval augmented generation. In particular, the disclosed principles integrate categorization techniques and a machine learning model to enhance RAG. For example, the disclosed system uses the categorization techniques and machine learning model to generate an input that is fed to an LLM. This input allows for significantly improved responses to be generated by the LLM that are more personalized to a specific user. This improves the accuracy and effectiveness of the response provided to the user. The disclosed techniques can also improve computational efficiencies by streamlining the data collection process prior to generation of the LLM prompt. In addition, it reduces the number of times users may request a re-processing or a re-summarization, thus conserving computational resources at the backend and further improving efficiencies.

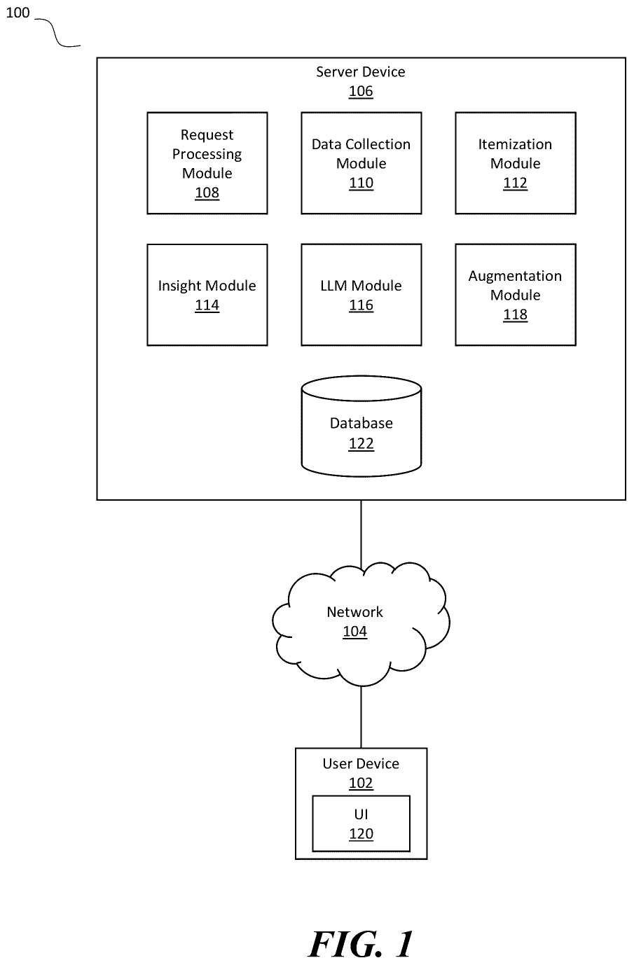

FIG. 1 is a block diagram of an example system 100 for personalized summarization techniques using retrieval augmented generation according to example embodiments of the present disclosure. The system 100 can include one or more user devices 102 (generally referred to herein as a “user device 102” or collectively referred to herein as “user devices 102”) that can access, via network 104, a request system managed by a server device 106. This connection enables a user operating the user device 102 to utilize a user interface (UI) 120 to consult the request system on the server 106. For example, the user can initiate a request to receive a summarization of his/her organization via the UI 120, which is transmitted to the server 106 for analysis. The server 106, via its various modules, generates a summary and transmits it back to the user device 102 for display to the user. For example, the request system could be part of various online services, such as an accounting software or other business management software. In some embodiments, the system 100 can include any number of user devices 102.

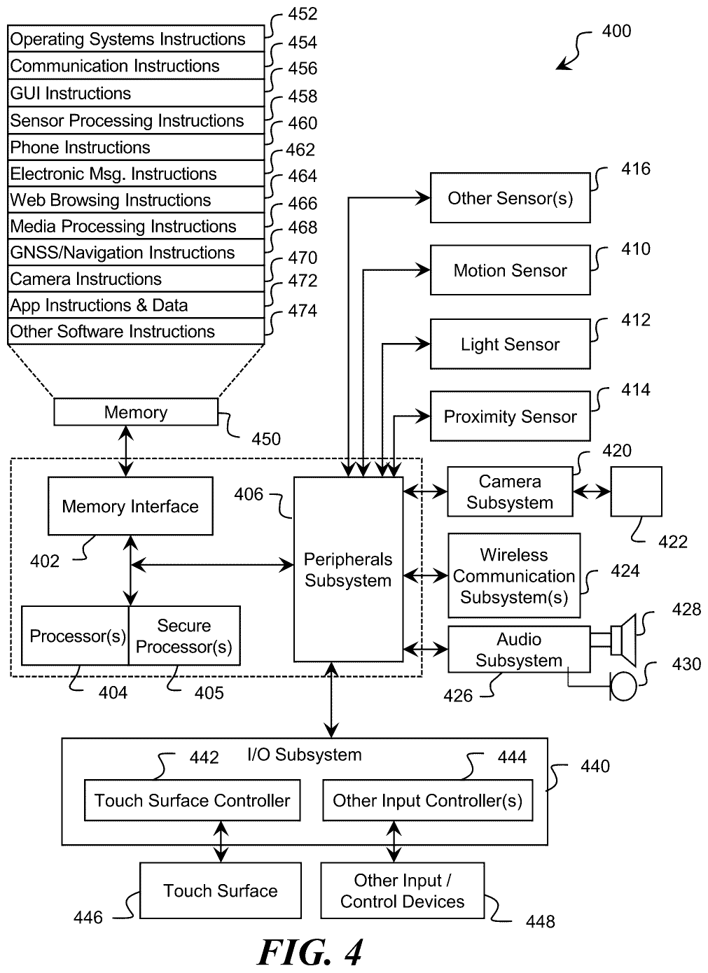

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 400 described below with respect to FIG. 4.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

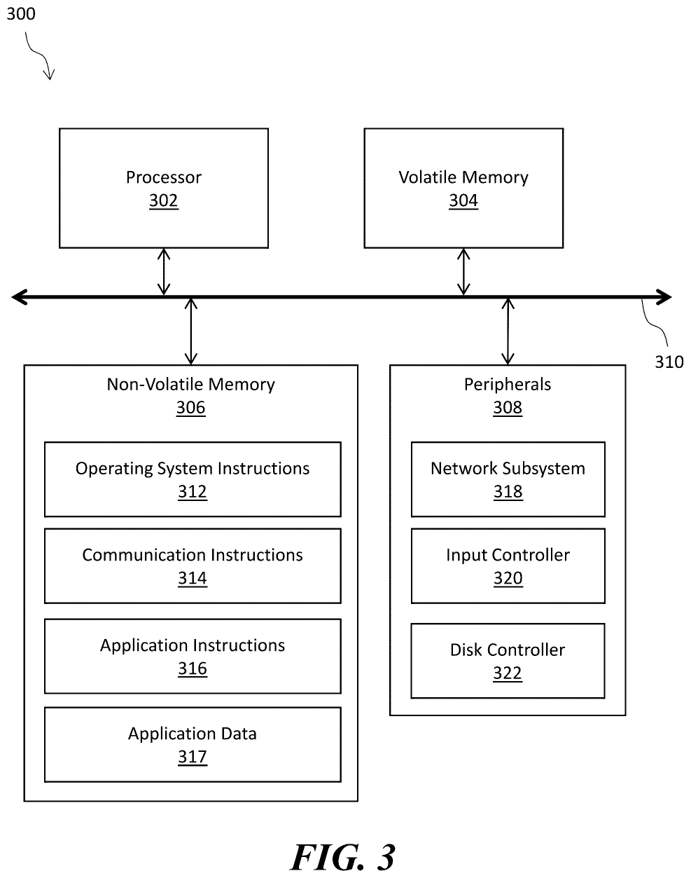

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 300 described below in the context of FIG. 3.

As shown in FIG. 1, the server 106 includes a request processing module 108, a data collection module 110, an itemization module 112, an insight module 114, and LLM module 116, and an augmentation module 118. The server 106 can also include a database 122 that is configured to store and maintain a knowledge base of information relevant to certain specialty areas. For instance, in the field of tax and accounting, the database 122 can include a plurality of tax forms, tax instructions, business tax-related documents (e.g., for U.S. states), tax data models, tax calculation logics, interview files, etc. In addition, the database 122 can be configured to store various demographic and financial information related to the userbase, such as bank transactions information, invoices, previous business descriptions, category selections, historical interaction data (e.g., parts of the software application that are frequently interacted with, time spent on such parts, questions previously asked, anomalies detected within the business, links clicked, previous actions executed), product information (e.g., stock keeping unit (SKU) information), and any other information relevant to each business and/or user. In some embodiments, the database 122 can be a vector database to enable vector searches to be performed to identify relevant documents and materials. One such example is a Chroma Database. In some embodiments, the embedded repository 128 can employ one or more of indexing and querying techniques that can be used for hierarchical clustering or partitioning. The use of such indexing and querying techniques can enable parallel processing, caching, and prefetching, which can minimize latency to store frequently accessed data in memory. Moreover, this can provide data compression and efficient storage without sacrificing query performance with fault tolerance and recovery.

In some embodiments, the request processing module 108 is configured to receive a user indication for a summary from a user device 102. For example, while a user is logged in and maneuvering within the relevant account or business management software, the user may request a summary via the UI 120, such as a business summary. In some embodiments, the request can be used for any kind of user interaction where a specific query is not transmitted but a personalized suggestion, summary, or other feedback is to be generated for the user. For example, in the context of a credit monitoring tool, a user could request a summary of their personal finance situation and how to improve it.

In some embodiments, the data collection module 110 is configured to compile data based on and or associated with the user who transmitted the indication for a summary. In some embodiments, the data collection module 110 can compile the data in response to the indication for the summary being received by the request processing module 108. In some embodiments, the data collection module 110 is configured to access various application programming interfaces (APIs) and artificial intelligence models. In some embodiments, the APIs can allow the data collection module 110 to access business information, such as profit/loss information, inventory information, transaction information, etc. In some embodiments, the artificial intelligence models can enable the data collection module 110 to obtain, for example, similar information, suggestions to improve, e.g., cash flow, suggestion to reduce, e.g., expenses, etc. In addition, the data collection module 110 can access the database 122 to compile information associated with the user, such as business information, financial information, and historical interaction information.

In some embodiments, the itemization module 112 is configured to itemize data, such as the compiled data created by the data collection module 110. In some embodiments, the itemization module 112 can be configured to itemize the information based on predetermined categorization buckets. For example, the itemization module 112 can determine which types of data have similar themes or topics, such as being related to profits. In addition, the itemization module 112 can be configured to feed the itemized data to the insight module 114, for example as an input to a machine learning model.

In some embodiments, the insight module 114 is configured to rank itemized data. For example, the insight module 114 can execute a machine learning model configured to analyze the itemized data received from the itemization module 112 and rank the data in importance to the user. In some embodiments, the machine learning model can be trained on various information to determine relevance levels for certain data to a user or associated business. For example, the machine learning model can be trained on various information from the database 122, such as tax forms, tax instructions, business tax-related documents (e.g., for U.S. states), tax data models, tax calculation logics, interview files, and various demographic and financial information related to the userbase, such as bank transactions information, invoices, previous business descriptions, category selections, historical interaction data (e.g., parts of the software application that are frequently interacted with, time spent on such parts, questions previously asked, anomalies detected within the business, links clicked, previous actions executed), product information (e.g., stock keeping unit (SKU) information), and any other information relevant to each business and/or user. In some embodiments, the insight module 114 is configured to rank the itemized data via a rule-based analysis. For example, rule-based analyses can include rules such as: 1) if a change in profit/loss percentage is above or below a specific value then rank higher; 2) a rule that makes items dependent on each other (i.e., if one item is unavailable and another gets ranked higher, if the first item is 0 then the other gets removed). In addition, the insight module 114 is configured to generate an LLM prompt with the ranked itemized compiled data and the original summary request. The insight module 114 can then feed this prompt to the LLM module 116 as an input. In some embodiments, the insight module 114 is configured to send a certain predefined number of pieces of data to the LLM module 116, for example a top ten entries.

In some embodiments, the LLM module 116 includes an LLM, such as e.g., GPT-3, -3.5, -4, PaLM, Ernie Bot, LLaMa, and others. In some embodiments, an LLM can include various transformed-based models trained on vast corpuses of data that utilize an underlying neural network. The LLM module 116 can receive an input, such as ranked itemized data from the insight module 114. The LLM module 116 is configured to analyze the input and generate a summary for each item individually. In addition, the LLM module 116 can format the summaries into a structured representation.

In some embodiments, the augmentation module 118 is configured to augment the summaries in the structured representation generated by the LLM module 116. For example, the augmentation module 118 can add recommended actions or other advice to each individual summary. In some embodiments, actions and advice can include various types of suggestions and recommendations, such as how to reduce expenses, improve cash flow, and others.

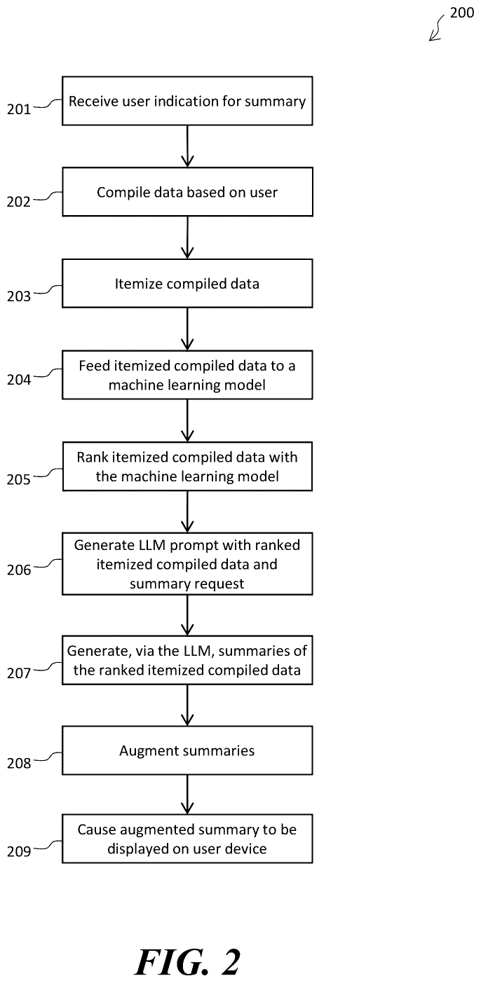

FIG. 2 is a flowchart of an example process 200 for personalized summarization techniques using retrieval augmented generation according to example embodiments of the present disclosure. In some embodiments, the process 200 can be performed by the server 106 in conjunction with a user, via user device 102, accessing a request system to request a summary, for example within an accounting or business management software platform. For example, a user may have an interface executing on the user device 102 via UI 120 where he/she will submit a request to the server 106.

At block 201, the request processing module 108 receives a user indication for a summary from a user device 102. For example, while a user is logged in and maneuvering within the relevant account or business management software, the user may request a summary via the UI 120, such as a business summary. At block 202, the data collection module 110 compiles data based on the user associated with the user device 102 or the account used to access the platform on the user device 102. In some embodiments, the data collection module 110 can compile the data in response to the request processing module 108 receiving the user indication. In some embodiments, compiling the data can include accessing various APIs and artificial intelligence models. In addition, compiling the data can include accessing the database 122 to obtain information associated with the user, such as business information, financial information, and historical interaction information, as well as any other information maintained within the database 122.

At block 203, the itemization module 112 itemizes the compiled data. In some embodiments, the itemization module 112 can itemize the compiled data based on predetermined categorization buckets. For example, the itemization module 112 can determine which types of data have similar themes, such as being related to profits. At block 204, the itemization module 112 feeds the itemized compiled data to the insight module 114. In some embodiments, feeding the itemized compiled data to the insight module 114 can include feeding the itemized compiled data to a machine learning model executed by the insight module 114. In some embodiments, as discussed above, the machine learning model can be trained on various information from the database 122, such as tax forms, tax instructions, business tax-related documents (e.g., for U.S. states), tax data models, tax calculation logics, interview files, and various demographic and financial information related to the userbase, such as bank transactions information, invoices, previous business descriptions, category selections, historical interaction data (e.g., parts of the software application that are frequently interacted with, time spent on such parts, questions previously asked, anomalies detected within the business, links clicked, previous actions executed), product information (e.g., stock keeping unit (SKU) information), and any other information relevant to each business and/or user.

At block 205, the insight module 114 ranks the itemized compiled data with the machine learning model discussed in relation to block 204. In some embodiments, the insight module 114 can, via the machine learning model, analyze the itemized data received from the itemization module 112 and rank the data by importance to the user. At block 206, the insight module 114 generates an LLM prompt with the ranked itemized compiled data and the original summary request. In addition, the insight module 114 can feed this prompt to the LLM module 116 as an input. In some embodiments, the insight module 114 is configured to send a certain predefined number of pieces of data to the LLM module 116, for example the top ten entries. At block 207, the LLM module 116 generates summaries of the ranked itemized compiled data. In some embodiments, this can include analyzing the input prompt and generating a summary for each item individually. In some embodiments, this can also include formatting the generated summaries into a structured representation. At block 208, the augmentation module 118 augments the summaries in the structured representation generated by the LLM module 116. In some embodiments, augmenting the summaries can include adding recommended actions or other advice. At block 209, the server 106 causes one or more of the augmented summaries to be displayed on the user device 102.

FIG. 3 is a diagram of an example server device 300 that can be used within system 100 of FIG. 1. Server device 300 can implement various features and processes as described herein. Server device 300 can be implemented on any electronic device that runs software applications derived from complied instructions, including without limitation personal computers, servers, smart phones, media players, electronic tablets, game consoles, email devices, etc. In some implementations, server device 300 can include one or more processors 302, volatile memory 304, non-volatile memory 306, and one or more peripherals 308. These components can be interconnected by one or more computer buses 310.

Processor(s) 302 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 310 can be any known internal or external bus technology, including but not limited to ISA, EISA, PCI, PCI Express, USB, Serial ATA, or FireWire. Volatile memory 304 can include, for example, SDRAM. Processor 302 can receive instructions and data from a read-only memory or a random access memory or both. Essential elements of a computer can include a processor for executing instructions and one or more memories for storing instructions and data.

Non-volatile memory 306 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 306 can store various computer instructions including operating system instructions 312, communication instructions 314, application instructions 316, and application data 317. Operating system instructions 312 can include instructions for implementing an operating system (e.g., Mac OS®, Windows®, or Linux). The operating system can be multi-user, multiprocessing, multitasking, multithreading, real-time, and the like. Communication instructions 314 can include network communications instructions, for example, software for implementing communication protocols, such as TCP/IP, HTTP, Ethernet, telephony, etc. Application instructions 316 can include instructions for various applications. Application data 317 can include data corresponding to the applications.

Peripherals 308 can be included within server device 300 or operatively coupled to communicate with server device 300. Peripherals 308 can include, for example, network subsystem 318, input controller 320, and disk controller 322. Network subsystem 318 can include, for example, an Ethernet of WiFi adapter. Input controller 320 can be any known input device technology, including but not limited to a keyboard (including a virtual keyboard), mouse, track ball, and touch-sensitive pad or display. Disk controller 322 can include one or more mass storage devices for storing data files; such devices include magnetic disks, such as internal hard disks and removable disks; magneto-optical disks; and optical disks.

FIG. 4 is an example computing device that can be used within the system 100 of FIG. 1, according to an embodiment of the present disclosure. In some embodiments, device 400 can be user device 102. The illustrative user device 400 can include a memory interface 402, one or more data processors, image processors, central processing units 404, and or secure processing units 405, and peripherals subsystem 406. Memory interface 402, one or more central processing units 404 and or secure processing units 405, and or peripherals subsystem 406 can be separate components or can be integrated in one or more integrated circuits. The various components in user device 400 can be coupled by one or more communication buses or signal lines. Moreover, the device 400 can utilize various cloud computing resources to perform certain application computations.

Sensors, devices, and subsystems can be coupled to peripherals subsystem 406 to facilitate multiple functionalities. For example, motion sensor 410, light sensor 412, and proximity sensor 414 can be coupled to peripherals subsystem 406 to facilitate orientation, lighting, and proximity functions. Other sensors 416 can also be connected to peripherals subsystem 406, such as a global navigation satellite system (GNSS) (e.g., GPS receiver), a temperature sensor, a biometric sensor, magnetometer, or other sensing device, to facilitate related functionalities.

Camera subsystem 420 and optical sensor 422, e.g., a charged coupled device (CCD) or a complementary metal-oxide semiconductor (CMOS) optical sensor, can be utilized to facilitate camera functions, such as recording photographs and video clips. Camera subsystem 420 and optical sensor 422 can be used to collect images of a user to be used during authentication of a user, e.g., by performing facial recognition analysis.

Communication functions can be facilitated through one or more wired and or wireless communication subsystems 424, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 424. The specific design and implementation of communication subsystems 424 can depend on the communication network(s) over which the user device 400 is intended to operate. For example, user device 400 can include communication subsystems 424 designed to operate over a GSM network, a GPRS network, an EDGE network, a WiFi or WiMax network, and a Bluetooth™ network. For example, wireless communication subsystems 424 can include hosting protocols such that device 400 can be configured as a base station for other wireless devices and or to provide a WiFi service.

Audio subsystem 426 can be coupled to speaker 428 and microphone 430 to facilitate voice-enabled functions, such as speaker recognition, voice replication, digital recording, and telephony functions. Audio subsystem 426 can be configured to facilitate processing voice commands, voice-printing, and voice authentication, for example.

I/O subsystem 440 can include a touch-surface controller 442 and or other input controller(s) 444. Touch-surface controller 442 can be coupled to a touch-surface 446. Touch-surface 446 and touch-surface controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 446.

The other input controller(s) 444 can be coupled to other input/control devices 448, such as one or more buttons, rocker switches, thumb-wheel, infrared port, USB port, and or a pointer device such as a stylus. The one or more buttons (not shown) can include an up/down button for volume control of speaker 428 and or microphone 430.

In some implementations, a pressing of the button for a first duration can disengage a lock of touch-surface 446; and a pressing of the button for a second duration that is longer than the first duration can turn power to user device 400 on or off. Pressing the button for a third duration can activate a voice control, or voice command, module that enables the user to speak commands into microphone 430 to cause the device to execute the spoken command. The user can customize a functionality of one or more of the buttons. Touch-surface 446 can, for example, also be used to implement virtual or soft buttons and or a keyboard.

In some implementations, user device 400 can present recorded audio and or video files, such as MP3, AAC, and MPEG files. In some implementations, user device 400 can include the functionality of an MP3 player, such as an iPod™. User device 400 can, therefore, include a 36-pin connector and or 8-pin connector that is compatible with the iPod. Other input/output and control devices can also be used.

Memory interface 402 can be coupled to memory 450. Memory 450 can include high-speed random access memory and or non-volatile memory, such as one or more magnetic disk storage devices, one or more optical storage devices, and or flash memory (e.g., NAND, NOR). Memory 450 can store an operating system 452, such as Darwin, RTXC, LINUX, UNIX, OS X, Windows, or an embedded operating system such as VxWorks.

Operating system 452 can include instructions for handling basic system services and for performing hardware dependent tasks. In some implementations, operating system 452 can be a kernel (e.g., UNIX kernel). In some implementations, operating system 452 can include instructions for performing voice authentication.

Memory 450 can also store communication instructions 454 to facilitate communicating with one or more additional devices, one or more computers and or one or more servers. Memory 450 can include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic messaging-related process and functions; web browsing instructions 464 to facilitate web browsing-related processes and functions; media processing instructions 466 to facilitate media processing-related functions and processes; GNSS/Navigation instructions 468 to facilitate GNSS and navigation-related processes and instructions; and or camera instructions 470 to facilitate camera-related processes and functions.

Memory 450 can store application (or “app”) instructions and data 472, such as instructions for the apps described above in the context of FIGS. 1-2. Memory 450 can also store other software instructions 474 for various other software applications in place on device 400. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A computing system comprising:
a processor; and
a non-transitory computer-readable storage device storing computer-executable instructions, the instructions operable to causing the processor to perform operations comprising:
receiving a user request for a summary from a user device associated with a user;
compiling data associated with the user;
itemizing the compiled data;
feeding the itemized compiled data to a machine learning model;
ranking, with the machine learning model, the itemized compiled data based on relevance to the user;
generating a large language model (LLM) prompt comprising the ranked itemized compiled data;
generating, via the LLM, a summary for each item of the ranked itemized compiled data;
augmenting the summaries; and
causing at least one augmented summary to be displayed on the user device.

2. The computing system of claim 1, wherein compiling the data associated with the user comprises accessing one or more application programming interfaces (APIs) to obtain one or more of profit/loss information, inventory information, and transaction information.

3. The computing system of claim 1, wherein compiling the data associated with the user comprises accessing one or more artificial intelligence models to obtain one or more recommended actions for the user.

4. The computing system of claim 1, wherein compiling the data associated with the user comprises compiling business information, financial information, and historical interaction information.

5. The computing system of claim 1, wherein itemizing the compiled data comprises itemizing the compiled data based on a plurality of predetermined buckets.

6. The computing system of claim 5, wherein itemizing the compiled data based on the plurality of predetermined buckets comprises determining that two or more entries have a related topic.

7. The computing system of claim 1, wherein feeding the itemized compiled data to the machine learning model comprises feeding the itemized compiled data to a machine learning model trained on business information, financial information, and historical interaction information.

8. The computing system of claim 1, wherein generating the LLM prompt comprises a top predefined number of entries from the ranked itemized compiled data.

9. The computing system of claim 1, wherein augmenting the summaries comprises adding one or more recommended actions associated with the item.

10. The computing system of claim 1, wherein generating, via the LLM, the summary for each item of the ranked itemized compiled data comprises formatting the generated summaries into a structured representation.

11. A computer-implemented method, performed by at least one processor, comprising:
a processor; and
receiving a user request for a summary from a user device associated with a user;
compiling data associated with the user;
itemizing the compiled data;
feeding the itemized compiled data to a machine learning model;
ranking, with the machine learning model, the itemized compiled data based on relevance to the user;
generating a large language model (LLM) prompt comprising the ranked itemized compiled data;
generating, via the LLM, a summary for each item of the ranked itemized compiled data;
augmenting the summaries; and
causing at least one augmented summary to be displayed on the user device.

12. The computer-implemented method of claim 11, wherein compiling the data associated with the user comprises accessing one or more application programming interfaces (APIs) to obtain one or more of profit/loss information, inventory information, and transaction information.

13. The computer-implemented method of claim 11, wherein compiling the data associated with the user comprises accessing one or more artificial intelligence models to obtain one or more recommended actions for the user.

14. The computer-implemented method of claim 11, wherein compiling the data associated with the user comprises compiling business information, financial information, and historical interaction information.

15. The computer-implemented method of claim 11, wherein itemizing the compiled data comprises itemizing the compiled data based on a plurality of predetermined buckets.

16. The computer-implemented method of claim 15, wherein itemizing the compiled data based on the plurality of predetermined buckets comprises determining that two or more entries have a related topic.

17. The computer-implemented method of claim 11, wherein feeding the itemized compiled data to the machine learning model comprises feeding the itemized compiled data to a machine learning model trained on business information, financial information, and historical interaction information.

18. The computer-implemented method of claim 11, wherein generating the LLM prompt comprises a top predefined number of entries from the ranked itemized compiled data.

19. The computer-implemented method of claim 11, wherein augmenting the summaries comprises adding one or more recommended actions associated with the item.

20. The computer-implemented method of claim 11, wherein generating, via the LLM, the summary for each item of the ranked itemized compiled data comprises formatting the generated summaries into a structured representation.
